(19) United States
(12) Patent Application Publication
(10) Pub. No.: US 2011/0096367 A1
(43) Pub. Date: Apr. 28, 2011

(54) Print Settings Verification Mechanism

(76) Inventors: Jason Charles Walp, Louisville, CO (US); James-Anthony Chauvin, Frederick, CO (US)

(21) Appl. No.: 12/604,867

(22) Filed: Oct. 23, 2009

(51) Int. Cl. G06K 15/02; G06K 19/00; G06K 7/10

(52) U.S. Cl. 358/3.28; 235/487; 235/462.01

(57) ABSTRACT

A method is disclosed. The method includes retrieving data associated with one or more printer settings to be used to print a document, encoding the printer settings data into machine readable data and printing the machine readable data on the document with print job data.

### FIELD OF THE INVENTION

This invention relates generally to the field of printing systems. More particularly, the invention relates to associating printer settings with printer output.

### BACKGROUND

Printers are common peripheral devices attached to computers. A printer allows a computer user to make a hard copy of documents that are created in a variety of applications and programs on a computer. To function properly, a channel of communication is established (e.g., via a network connection) between the printer and the computer to enable the printer to receive commands and information from the host computer.

On occasion a printer user may be dissatisfied with the quality of documents produced by a printer. On such occasions the user may send hardcopy samples to a product support group provided by the printer manufacturer. However in most instances, the various settings used to print the samples are either not supplied, or are unclear.

Even when the settings are provided, they are often in the form of handwritten descriptions. However, providing handwritten descriptions is not accurate due to the probability of errors attributed to misreading the data. Even in instances where a printed list of settings are provided with each hardcopy print, they can be lost if somehow separated from the prints. Upon such an occurrence, there is no way to know which settings are applied to a particular hardcopy print.

Thus, a mechanism to enable reliable verification of print settings for a print sample is desired.

### SUMMARY

In one embodiment, a method is disclosed. The method includes retrieving data associated with one or more printer settings to be used to print a document, encoding the printer settings data into machine readable data and printing the machine readable data on the document with print job data.

In another embodiment, a printer is disclosed. The printer includes a control unit having a selection unit to retrieve data associated with one or more printer settings to be used to print a document and an encoder to encode the printer settings data into machine readable data. The printer also includes a print head to print the machine readable data on the document with print job data.

### BRIEF DESCRIPTION OF THE DRAWINGS

A better understanding of the present invention can be obtained from the following detailed description in conjunction with the following drawings, in which:

FIG. 1 illustrates one embodiment of a system;

FIG. 2 illustrates one embodiment of a printing system;

FIG. 3 illustrates one embodiment of a control unit;

FIG. 4 illustrates one embodiment of a sample printout; and

FIG. 5 illustrates one embodiment of a computer system.

### DETAILED DESCRIPTION

A mechanism to provide print settings with a sample printout is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

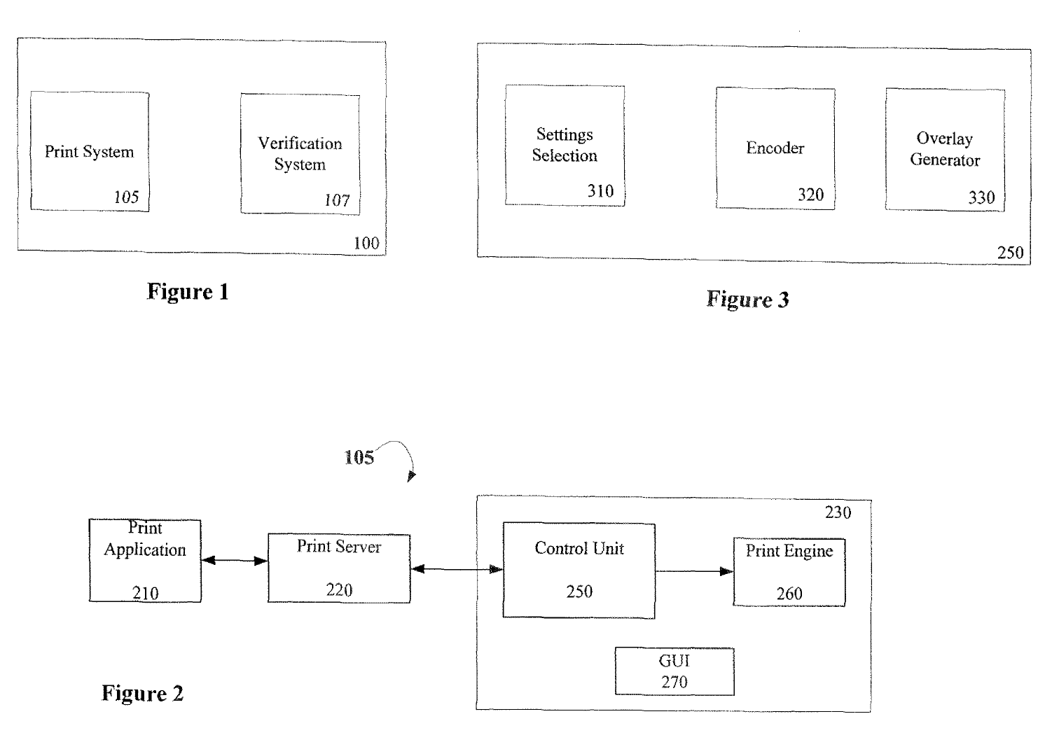

FIG. 1 illustrates one embodiment of a system 100, which includes a printing system 105 and a verification system 107. Printing system 105 is a network implemented to generate a hard copy of documents created at a computer system. Verification system 107 is provided to verify settings used to generate a document at verification system 107, as will be discussed in more detail below.

FIG. 2 illustrates one embodiment of a printing system 105. Printing system 105 includes a print application 210, a server 220 and printer 230. Printer 230 includes a control unit 250, a print engine 260 and a graphical user interface (GUI) 270. Print application 210 makes a request for the printing of a document. In one embodiment, print application 210 provides a Mixed Object Document Content Architecture (MO:DCA) data stream to print server 220.

In other embodiments print application 210 may also provide PostScript (P/S) and PDF files for printing. P/S and PDF files are printed by first passing them through a pre-processor (not shown), which creates resource separation and page independence so that the P/S or PDF file can be transformed into an Advanced Function Presentation (AFP) MO:DCA data stream prior to being passed to print server 220.

Print server 220 processes pages of output that mix all of the elements typically found in presentation documents, e.g., text in typographic fonts, electronic forms, graphics, image, lines, boxes, and barcodes. The AFP MO:DCA data stream is composed of architected, structured fields that describe each of these elements.

In one embodiment, print server 220 communicates with control unit 250 via an Intelligent Printer Data Stream (IPDS). The IPDS data stream is similar to the AFP data stream, but is built specific to the destination printer in order to integrate with each printer's specific capabilities and command set, and to facilitate the interactive dialog between the print server 220 and the printer. The IPDS data stream may be built dynamically at presentation time, e.g., on-the-fly in real time. Thus, the IPDS data stream is provided according to a device-dependent bi-directional command/data stream.

According to one embodiment, control unit 250 processes and renders objects received from print server 220 and provides sheet maps for printing to print engine 260. In a further embodiment, control unit 250 is implemented to gather various print environment variables, encode the data in a machine readable format and facilitate the printing of the machine readable data on a hardcopy printout. However, in other embodiments, the data may be encoded into a text format.

In such an embodiment, a system operator configures printer 230 using GUI 270 to enter a sample print mode where sample print job data is retrieved from storage (not shown) and printed at printer 230. Although in other embodiments, the print job data may be received from print server 220. In one embodiment, the machine readable data is printed over the print job data on the hardcopy printout. However, in other embodiments the machine readable data may be printed in the margin on the hardcopy printout.

FIG. 3 illustrates one embodiment of a control unit 250. Control unit 250 includes settings selection unit 310, encoder 320 and overlay generator 330. Settings selection unit 310 reads various printer settings that are to be included in a hardcopy printout. According to one embodiment, a system operator uses GUI 270 to select which printer settings are to be included in the printout. Exemplary settings may include printer firmware version, halftones, ICC profiles, print head temperature, etc.

Once the desired settings are entered settings selection unit 310 retrieves the selected values. Encoder 320 encodes the settings values into a machine readable format. In one embodiment, the encoder 320 encodes the settings into a 2D barcode format. However in other embodiments, different machine readable, or barcode configurations (e.g., linear or 3D barcodes) may be implemented.

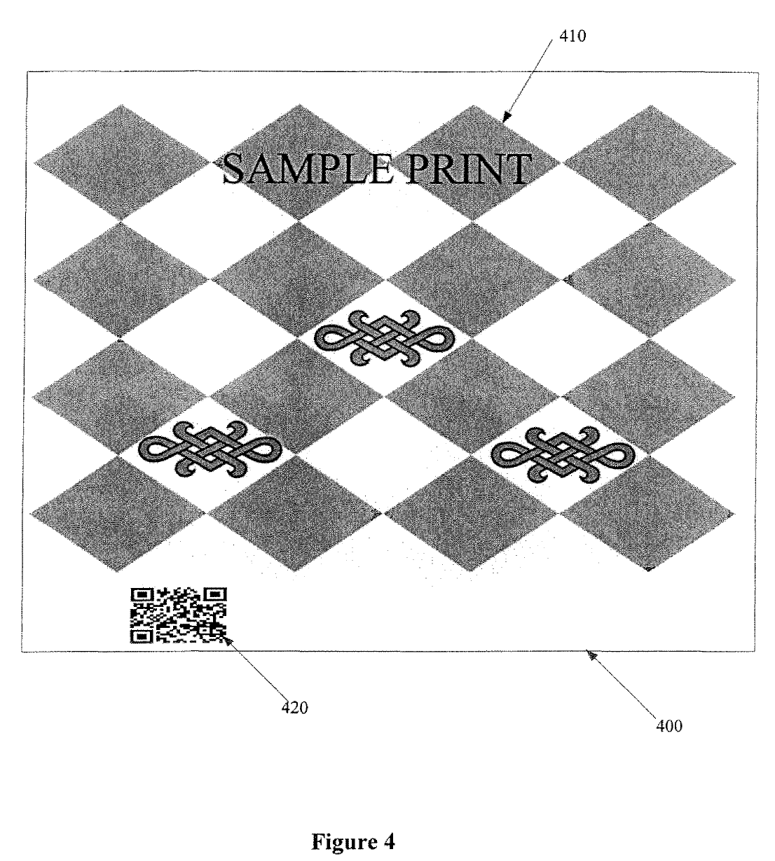

Overlay generator 330 collects the machine readable settings data and generates an overlay that is inserted into a print job data stream. Thus, the machine readable data is rasterized along with the print job data to produce the hardcopy printout. FIG. 4 illustrates one embodiment of a sample printout 400. Printout 400 includes print job data 410 and barcode 420 including the settings data.

At some future time printout 400 is taken to verification system 107 for analysis. In one embodiment, printout 400 is analyzed for support purposes in order to assist the printer 230 owner solve print issues. However, verification system 107 may also be used for development and functional testing and archiving. In still a further embodiment, verification system 107 may be used for print quality and color science applications to perform color profiling, testing, etc.

In one embodiment, verification system 107 is a computer system having a reader capable of reading the machine readable format of the settings data (e.g., barcode 420) used to printout the print job data 410 on printout 400. Subsequently, verification system 107 decodes the settings data read from barcode 420. In a further embodiment, verification system 107 takes the settings data and automatically populates fields in a report to which analysis data can be added at a later time. Note that in embodiments where the printer settings are encoded and printed as a text overlay, a user may read the text and enter the settings into verification 107.

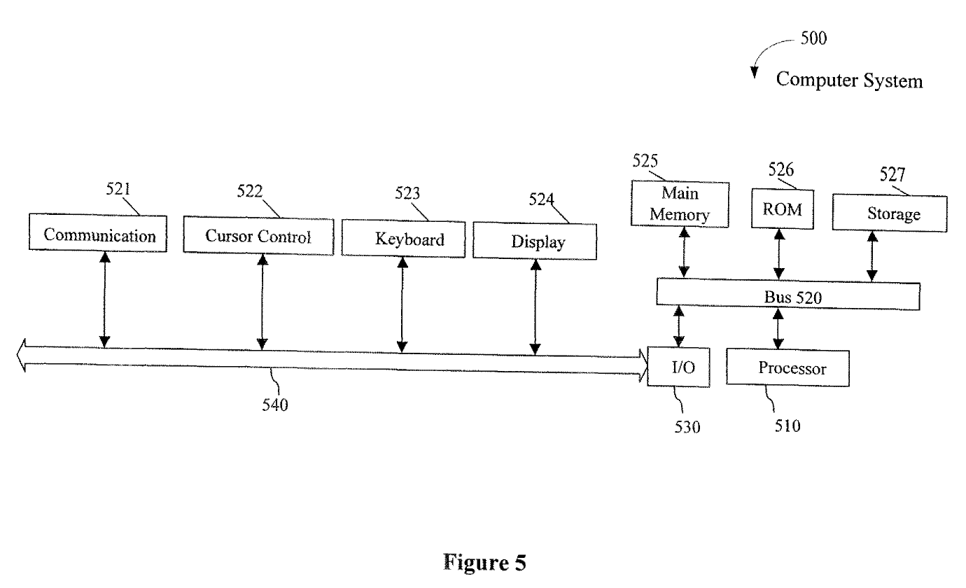

FIG. 5 illustrates a computer system 500 on which data verification system 107 and/or server 220 may be implemented. Computer system 500 includes a system bus 520 for communicating information, and a processor 510 coupled to bus 520 for processing information.

Computer system 500 further comprises a random access memory (RAM) or other dynamic storage device 525 (referred to herein as main memory), coupled to bus 520 for storing information and instructions to be executed by processor 510. Main memory 525 also may be used for storing temporary variables or other intermediate information during execution of instructions by processor 510. Computer system 500 also may include a read only memory (ROM) and or other static storage device 526 coupled to bus 520 for storing static information and instructions used by processor 510.

A data storage device 525 such as a magnetic disk or optical disc and its corresponding drive may also be coupled to computer system 500 for storing information and instructions. Computer system 500 can also be coupled to a second I/O bus 550 via an I/O interface 530. A plurality of I/O devices may be coupled to I/O bus 550, including a display device 524, an input device (e.g., an alphanumeric input device 523 and or a cursor control device 522). The communication device 521 is for accessing other computers (servers or clients). The communication device 521 may comprise a modem, a network interface card, or other well-known interface device, such as those used for coupling to Ethernet, token ring, or other types of networks.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A method comprising:
retrieving data associated with one or more printer settings to be used to print a document;
encoding the printer settings data into machine readable data; and
printing the machine readable data on the document with print job data.

2. The method of claim 1 further comprising inserting the machine readable data into a print job data stream prior as an overlay to printing the document.

3. The method of claim 1 wherein the machine readable data is printed over the print job data on the document.

4. The method of claim 1 wherein the machine readable data is printed in a margin of the document.

5. The method of claim 1 wherein the printed machine readable data is a barcode.

6. The method of claim 1 further comprising analyzing the document at a verification system.

7. The method of claim 6 wherein analyzing the document at the verification system comprises:
reading the machine readable data; and
decoding the machine readable data to retrieve the printer settings data.

8. The method of claim 7 further comprising automatically populating fields of a report with the printer settings data.

9. A printer comprising:
a control unit, including:
a selection unit to retrieve data associated with one or more printer settings to be used to print a document; and
an encoder to encode the printer settings data into machine readable data; and
a print head to print the machine readable data on the document with print job data.

10. The printer of claim 9 wherein the control unit further comprises an overlay generator to generate an overlay including the machine readable data and to insert the overlay into a print job data stream.

11. The printer of claim 9 wherein the machine readable data is printed over the print job data on the document.

12. The printer of claim 9 wherein the machine readable data is printed in a margin of the document.

13. The printer of claim 9 wherein the printed machine readable data is a barcode.

14. The printer of claim 9 further comprising a graphical user interface to enable selection of the one or more printer settings to be included in the machine readable data.

15. The printer of claim 14 wherein the printer settings include at least one of a printer firmware version, halftones, ICC profiles and print head temperature.

16. A system comprising:
a printer having:
a selection unit to retrieve data associated with one or more printer settings to be used to print a document;
an encoder to encode the printer settings data into machine readable data;
a print head to print the machine readable data on the document with print job data; and
a verification system to verify the printer settings used to generate the document.

17. The system of claim 16 wherein the verification system includes a reader to read the machine readable data.

18. The system of claim 17 wherein the verification system decodes the machine readable data to retrieve the printer settings data.

19. The system of claim 17 wherein the verification system automatically populates fields of a report with the printer settings data.

20. The printer of claim 16 wherein the printer further comprises an overlay generator to generate an overlay including the machine readable data and to insert the overlay into a print job data stream.
